(19) United States
(12) Patent Application Publication
(10) Pub. No.: US 2024/0093382 A1
(43) Pub. Date: Mar. 21, 2024

(54) SYSTEMS AND METHODS FOR PRODUCING ONE OR MORE CHEMICALS USING CARBON DIOXIDE PRODUCED BY FERMENTATION

(71) Applicant: POET Research, Inc., Sioux Falls, SD (US)

(72) Inventors: David Charles Carlson, Brandon, SD (US); Neil D. Anderson, Sioux Falls, SD (US)

(21) Appl. No.: 18/124,972

(22) Filed: Mar. 22, 2023

Related U.S. Application Data
(60) Provisional application No. 63/322,896, filed on Mar. 23, 2022.

(51) Int. Cl. C25B 1/04; C12F 3/02; C25B 15/021; C25B 15/08

(52) U.S. Cl. CPC C25B 1/04; C12F 3/02; C25B 15/021; C25B 15/08

(57) ABSTRACT

Systems and methods for making a reaction product using carbon dioxide produced at a bioprocessing facility. The bioprocessing facility involves fermenting a fermentable composition to generate at least one target biochemical and carbon dioxide. At least a portion of the carbon dioxide is reacted with at least one reactant to form at least one reaction product.

### CROSS-REFERENCE TO RELATED APPLICATION

This nonprovisional patent application claims the benefit of U.S. Provisional Patent Application Ser. No. 63/322,896, filed on Mar. 23, 2022, wherein said provisional patent application is incorporated herein by reference in its entirety.

### BACKGROUND

The present disclosure relates to utilizing carbon dioxide from fermentation in a bioprocessing facility.

Bioprocessing of feedstocks to produce various bioproducts is an increasingly important source of products including such things as feed, food, fuel, pharmaceuticals, and other chemicals. There is a continuing need for utilizing various outputs of a bioprocessing facility and/or reducing the carbon intensity of bioprocessing facilities.

### SUMMARY

The present disclosure involves systems and methods for making a reaction product using carbon dioxide produced at a bioprocessing facility. The bioprocessing facility involves fermenting a fermentable composition to generate at least one target biochemical and carbon dioxide. At least a portion of the carbon dioxide is reacted with at least one reactant to form at least one reaction product.

The present disclosure includes embodiments of a method of making a reaction product using carbon dioxide produced at a bioprocessing facility, wherein the method includes:
fermenting a fermentable composition at a bioprocessing facility, wherein fermenting generates at least one target biochemical and carbon dioxide;
reacting at least one reactant and carbon dioxide to form the at least one reaction product via an exothermic reaction, wherein at least a portion of the carbon dioxide is from the fermenting; and
using at least a portion of thermal energy from the exothermic reaction in the bioprocessing facility.

The present disclosure also includes embodiments of a facility that includes:
a bioprocessing facility including:
   a fermentation system configured to ferment a fermentable composition and generate at least one target biochemical and carbon dioxide; and
   one or more systems configured to use thermal energy for one or more processes in the bioprocessing facility;
a chemical production system that is co-located with the bioprocessing facility, wherein the chemical production system is in fluid communication with the fermentation system to receive at least a portion of the carbon dioxide, wherein the chemical production system includes:
   a source of at least one reactant that can react with the carbon dioxide via an exothermic reaction to produce at least one reaction product; and
   a reaction vessel configured to react the at least one reactant and carbon dioxide to form the at least one reaction product via the exothermic reaction,
      wherein the chemical production system is configured to transport thermal energy from the exothermic reaction, wherein the facility is configured to use at least a portion of the thermal energy to generate electricity for the bioprocessing facility and/or wherein the facility is configured to use at least a portion of the thermal energy in one or more systems in the bioprocessing facility, wherein the one or more systems are chosen from an evaporator system, a distillation system, a dryer system, a power generation system, and combinations thereof.

### BRIEF DESCRIPTION OF THE DRAWINGS

Various examples of the present disclosure will be discussed with reference to the appended drawings. These drawings depict only illustrative examples of the disclosure and are not to be considered limiting of its scope.

FIG. 1A is a schematic showing an illustrative example of a facility and process for making a reaction product at a bioprocessing facility using “green” carbon dioxide and at least one reactant via an exothermic reaction and using at least a portion of thermal energy from the exothermic reaction in the bioprocessing facility;

FIG. 1B is a schematic showing an illustrative example of supplying oxygen from the electrolysis system to one or more combustion processes/systems shown in FIG. 1A;

FIG. 2A is a schematic showing an illustrative example of a facility and process for making ethanol at a corn ethanol bioprocessing facility;

FIG. 2B is a schematic showing an illustrative example of a facility and process for integrating the corn ethanol bioprocessing facility of FIG. 2A with a chemical production system for making methane using “green” carbon dioxide and “green” hydrogen via an exothermic reaction and using at least a portion of thermal energy from the exothermic reaction in the corn ethanol bioprocessing facility; and

FIG. 2C is a schematic showing an illustrative example of supplying oxygen from the electrolysis system to the combustion processes/systems shown in FIG. 2B.

### DETAILED DESCRIPTION

The present disclosure relates to bioprocessing facilities. As used herein, a bioprocessing facility refers to a facility that can produce one or more bioproducts by converting biomass feedstock via one or more physical processes, one or more chemical processes, one or more bioprocesses, and combinations thereof. Non-limiting examples of bioprocessing facilities include dry mills, wet mills, biofuel production facilities, pharmaceutical production facilities, soy processing facilities, breweries, bakeries, and the like.

A bioproduct refers to a product derived from a biological, renewable resource. For example, a bioproduct can be a component of biomass feedstock that is liberated from the biomass feedstock (e.g., corn oil from corn grain) and/or can include a chemical (“biochemical” or “target biochemical”) that is produced by a biocatalyst (e.g., microorganism and/or enzyme) such as, for example, alcohol produced by yeast fermenting sugar. Non-limiting examples of bioproducts produced in a bioprocessing facility include one or more of fuel, feed, food, pharmaceuticals, beverages and precursor chemicals. In some embodiments, a bioproduct includes, among others, one or more monomeric sugars, one or more enzymes, one or more oils, one or more alcohols (e.g., ethanol, butanol, and the like), fungal biomass, amino acids, and one or more organic acids (e.g., lactic acid), and combinations thereof.

In some embodiments, one or more bioprocesses are carried out in a bioprocessing facility utilizing living cells (one or more microorganisms) and/or their components (e.g., enzymes produced by a microorganism) to obtain a desired bioproduct. Non-limiting examples of bioprocesses include one or more of hydrolysis (e.g., enzymatic hydrolysis), aerobic fermentation, or anaerobic fermentation. In some embodiments, a bioprocess includes saccharification and fermentation of a plant-based feedstock into a biofuel via enzymatic hydrolysis and yeast-based fermentation of the hydrolysate (e.g., a grain-to-ethanol biofuel facility).

According to one aspect of the present disclosure, methods and systems are described for making a reaction product at a bioprocessing facility using “green” carbon dioxide and at least one reactant. “Green” carbon dioxide refers to carbon dioxide that is produced via, e.g., fermentation using feedstocks that themselves absorb carbon from the atmosphere such that the “green” carbon dioxide contains recycled carbon, e.g., from a gas in the air to carbon-based chemicals in plants and back to a gas as a product of fermentation of plant material. Examples of bioprocessing facilities that produce “green” carbon dioxide include facilities that treat waste and facilities that produce fermented foods and drinks, animal food, pharmaceuticals, enzymes, and biofuels using for example microorganisms such as bacteria and fungi.

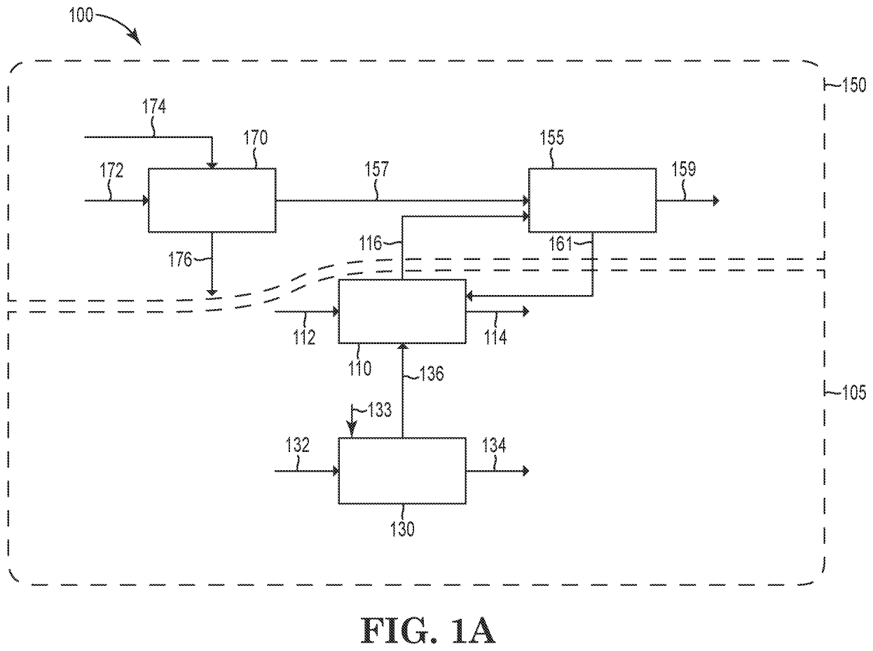

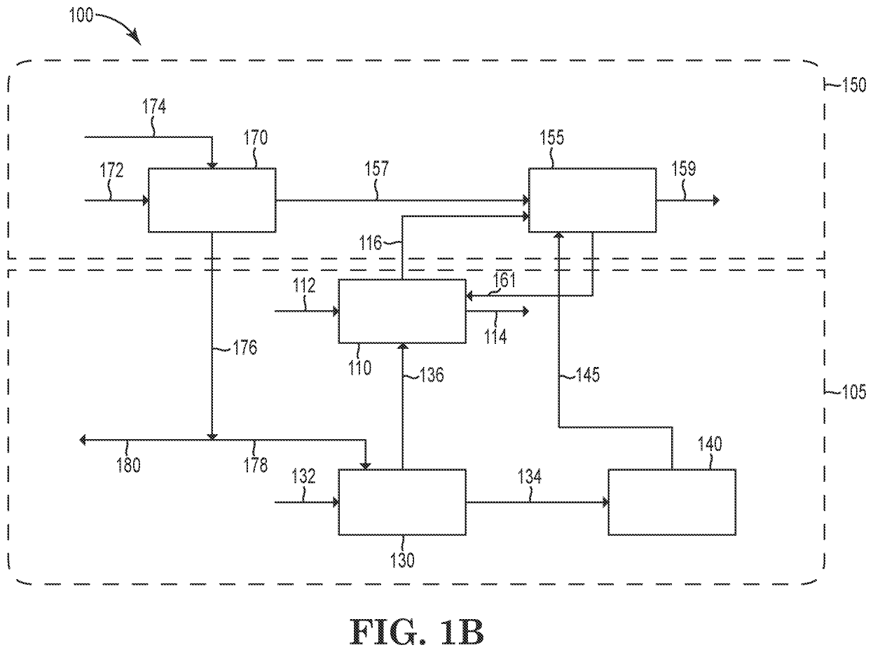

According to another aspect of the present disclosure, at least one reactant reacts with carbon dioxide produced at a bioprocessing facility to form at least one reaction product via an exothermic reaction, and at least a portion of thermal energy from the exothermic reaction is used by the bioprocessing facility. A non-limiting embodiment of a facility and process for making a reaction product at a bioprocessing facility using “green” carbon dioxide and at least one reactant via an exothermic reaction and using at least a portion of thermal energy from the exothermic reaction for the bioprocessing facility will be illustrated with reference to FIG. 1A.

As shown in FIG. 1, facility 100 includes a bioprocessing facility 105 having a primary system 110 that receives at least one feedstock 112 and produces one or more bioproducts 114.

Primary system 110 includes at least one fermentation system that is configured to ferment a fermentable composition (also referred to as a fermentable mash) and generate at least one target biochemical and carbon dioxide.

Non-limiting examples of a source of material to provide a fermentable composition include one or more of microorganisms, enzymes, carbon sources (e.g., feedstock), aqueous compositions (e.g., fresh water, backset, etc.), nutrient sources (e.g., feedstock), etc. In some embodiments, a feedstock can function as a carbon source and/or a nutrient source, and can be used to form a fermentable composition. A feedstock can include one or more components that are utilized by a microorganism to produce one or more bioproducts via a bioprocess. Non-limiting examples of feedstocks can be derived from biomass (e.g., plant-based) and may include, e.g., monosaccharides such as glucose and fructose, disaccharides such as sucrose and lactose, and more complex polysaccharides such as starch, cellulose, hemicellulose, and pectin. These biomass-derived feedstocks may come from the seed, sap, stems, and leaves of plants. A wide variety of plant-based feedstocks can be used according to the present disclosure such as sugar beets, sugar cane, grains, legumes, crop residues (e.g., husks, stems, corn stover, sugarcane bagasse, wheat straw), grasses, and woody plants. In some embodiments, feedstock can be derived from corn, sorghum, wheat, rice, barley, soybean, rapeseed, oats, millet, rye, corn stover, straw, bagasse and the like. In some embodiments, a feedstock can include whole ground grain (e.g., corn flour) formed via, e.g., a dry-grind process. In some embodiment, a feedstock can include one or more cellulosic polysaccharides (e.g., grain kernel fiber, crop waste, wood, municipal waste, etc.), and combinations thereof.

In some embodiments, a primary system 110 can include one or more feedstock systems to process feedstock from one form into another form prior to fermentation. For example, a feedstock system can include one or more size-reduction devices to reduce the size of raw feedstock such as grain and/or further reducing the size of ground grain that has previously been reduced in size. Methods for reducing the size of feedstock, e.g., corn and/or previously ground corn, into fine particles prior to fermentation include dry methods such as passing corn through one or more hammer mills, ball mills and/or roller mills or wet methods such as passing a ground grain slurry through one or more mills such as a disc mill, roller mill, colloid mill, ball mill or other type of milling device.

In some embodiments, a ground feedstock can be mixed with an appropriate amount of water (e.g., in a slurry tank) to form at least a portion of a fermentable composition (sometimes referred to as a mash). In some embodiments, whole ground corn can be mixed with liquid at about 20 to about 50 wt-% or about 25 to about 45 wt-% dry whole ground corn based on the total weight of the slurry. Whole ground corn can include starch, fiber, protein, oil, endogenous enzymes, amino acids, etc.

One or more exogenous microorganisms can be present in the fermentable composition of a fermentation system to produce beer that includes at least one or more biochemical bioproducts. Fermentation by a microorganism can produce biomass (e.g., single cell protein (SCP)), extracellular metabolites (e.g., alcohol such as ethanol), intracellular metabolites (e.g., enzymes), and combinations thereof. Non-limiting examples of such microorganisms include one or more of ethanologens, butanologens, and the like. Exemplary microorganisms include one or more of yeast, algae, or bacteria. For example, yeast may be used to convert the sugars to an alcohol such as ethanol. Suitable yeast includes any variety of commercially available yeast, such as commercial strains of Saccharomyces cerevisiae.

Optionally, one or more additional, exogenous materials may be utilized in a fermentable composition. Non-limiting examples of such materials include one or more of enzymes, phosphate, citric acid, ionic additives, and the like.

A fermentation system can include one or more vessels that are adapted to expose a fermentable composition to conditions suitable for converting sugars such as glucose to one or more bioproducts. As used herein, a “vessel” refers to any vessel that permits a bioproduct to be formed from a microorganism via fermentation. In some embodiments, a vessel can refer to a bioreactor adapted or configured to expose a fermentable composition to fermentation conditions. Non-limiting examples of vessels that can expose a fermentable composition to fermentation conditions include fermenters, beer wells, and the like. Two or more vessels may be arranged in any desired configuration such as parallel or series.

A fermentation system is configured to expose fermentable composition to fermentation conditions so that one or more microorganisms can convert one or more components in the fermentable composition such as sugars into a beer that includes one or more target bioproducts. Fermentation conditions include one or more conditions such as pH, time, temperature, aeration, stirring, and the like.

The pH of a fermentable composition can be at a pH that helps a microorganism produce one or more target bioproducts in a desired quantity. In some embodiments, the pH is greater than 3.5, e.g., from 3.5 to 7, from 3.5 to 5.5, or even from 3.5 to 4.5. Techniques for adjusting and maintaining pH include, e.g., adding one or more acidic materials and/or adding one or more basic materials.

With respect to temperature and time, the contents of a fermentable composition can be maintained at temperature for time period helps a microorganism produce one or more target bioproducts in a desired quantity. In some embodiments, the temperature of a fermentable composition can be at a temperature in a range from 20° C. to 45° F., from 25° C. to 40° C., or even from 30° C. to 40° C. In some embodiments, primary fermentation can occur for a time period up to 72 hours, e.g., from 1 hour to 48 hours, from 2 hours to 48 hours, or even from 10 hours to 30 hours.

Fermentation can be performed under anaerobic conditions and/or aerobic conditions. For example, fermentation can be performed under aerobic conditions for at least a portion of the fermentation and performed under anaerobic conditions for another portion of fermentation. Alternatively, all of fermentation can be performed under anaerobic conditions or under aerobic conditions. Anaerobic or aerobic conditions are selected based on the microorganism and the “target” biochemical or biochemicals chosen to be produced by a microorganism even though there may de minimis amounts of “non-target” biochemicals that are also produced by the microorganism. Anaerobic conditions means that the fermentation process is conducted without any intentional introduction of oxygen-containing gases such as with equipment like blowers, compressors, etc., that could operate to create an aerobic environment suitable for aerobic fermentation. It is noted that while simply stirring a fermentable composition to keep reactor contents homogenous may or may not introduce a de minimis amount of an oxygen-containing gas such as air in some embodiments, stirring alone may not create conditions that would be considered “aerobic conditions” as used herein. However, if desired, the contents of a fermenter could be mixed using appropriate equipment such that sufficient oxygen is introduced throughout the fermentable composition to create an aerobic environment suitable for aerobic fermentation (see below).

Aerobic conditions means that fermentation is performed with intentional introduction of one or more oxygen-containing gasses (“aeration”) to create an aerobic environment suitable for aerobic fermentation so that oxygen can be consumed by one or more microorganisms and, e.g. in the case of yeast, selectively favor the production of enzymes via an aerobic metabolic pathway as compared to an anaerobic pathway which favors production of biochemicals (e.g., alcohol, organic acids, and the like). A fermentation system may incorporate aeration by including one or more blowers, spargers, gas compressors, mixing devices, and the like, that are in fluid communication with one or more fermentation vessels and that can introduce an oxygen-containing gas (e.g., air) into a fermentable composition during at least a portion of fermentation. For example, an oxygen-containing gas can be sparged into a fermentable composition so that the gas bubbles up and through the fermentable composition and oxygen transfers into the fermentable composition. As another example, an oxygen-containing gas can be introduced into the headspace of a fermenter so that the gas diffuses into the fermentable composition.

Optionally, in addition to aeration, a fermentable composition can be agitated or mixed to facilitate transferring oxygen into and throughout the fermentable composition so as to achieve an aerobic environment. For example, a continuous stirred tank reactor (CSTR) can be used to agitate or mix the fermentable composition. The speed of the stirring mechanism (rpms) can be adjusted based on a variety of factors such as tank size, slurry viscosity, and the like. As mentioned above, in addition to mixing the contents of a composition, mixing can be selected, if desired, to intentionally incorporate oxygen to a fermentable composition to facilitate aerobic fermentation.

A fermentation system can be operated according to batch fermentation, fed-batch fermentation, or continuous fermentation (continuous feed and discharge from a vessel such as a fermenter).

Also, a fermentation system according to the present disclosure can conduct fermentation sequentially or simultaneously with respect to a polysaccharide hydrolysis/saccharification process (e.g., jet-cooking and/or enzymatic hydrolysis). Saccharification and fermentation can occur simultaneously according to what is known as “simultaneous saccharification and fermentation” (“SSF”). Sequential hydrolysis and fermentation can also be referred to as separate hydrolysis and fermentation (SHF).

An example of an SSF involves forming a slurry that includes a starch-containing grain such as corn. The slurry can be combined with a microorganism to form a fermentable composition so that at least a portion of starch in the fermentable composition is hydrolyzed by one or more enzymes to produce monosaccharides. As the monosaccharides are produced, they can be metabolized by a microorganism into a target biochemical product. For example, sugar (glucose, xylose, mannose, arabinose, etc.) that is generated from saccharification can be fermented into one or more biochemicals (e.g., butanol, ethanol, and the like).

Alternatively, an SHF process may include a dedicated saccharification process that is separate from a fermentation process (either in the same or separate vessel). For example, after forming an aqueous slurry that includes the biomass feedstock (e.g. corn material from a milling system) the aqueous slurry can be subjected to saccharification in one or more slurry tanks to break down (hydrolyze) at least a portion of the polysaccharides, e.g. starch, cellulose, hemicellulose, etc., into oligosaccharides and/or monosaccharides (e.g. glucose, xylose, mannose, arabinose, etc.) that can be used by microorganisms (e.g., yeast) in a subsequent fermentation process.

Saccharification can be performed by a variety of mechanisms. For example, heat and/or one or more enzymes can be used to form one or more monosaccharides by saccharifying one or more oligosaccharides and/or one or more polysaccharides that are present in a polysaccharide such as starch. In some embodiments, a relatively low temperature saccharification process (whether used in SSF or SHF) involves enzymatically hydrolyzing at least a portion of starch in an aqueous slurry at a temperature below starch gelatinization temperatures, so that saccharification occurs directly from the raw native insoluble starch to soluble glucose while bypassing conventional starch gelatinization conditions, which are typically in a range of 57° C. to 93° C. depending on the starch source and polysaccharide type. In some embodiments, saccharification includes using one or more enzymes (e.g., alpha-amylases and/or gluco-amylases) to enzymatically hydrolyze at least a portion of the starch in the aqueous slurry at a temperature of 40° C. or less to produce a slurry that includes glucose. In some embodiments, enzymatic hydrolysis occurs at a temperature in the range of from 25° C. to 35° C. to produce a slurry that includes glucose. Non-limiting examples of converting raw starch to glucose are described in U.S. Pat. No. 7,842,484 (Lewis), U.S. Pat. No. 7,919,289 (Lewis), U.S. Pat. No. 7,919,291 (Lewis et al.), U.S. Pat. No. 8,409,639 (Lewis et al.), U.S. Pat. No. 8,409,640 (Lewis et al.), U.S. Pat. No. 8,497,082 (Lewis), U.S. Pat. No. 8,597,919 (Lewis), U.S. Pat. No. 8,748,141 (Lewis et al.), 2014-0283226 (Lewis et al.), and 2018-0235167 (Lewis et al.), wherein the entirety of each patent document is incorporated herein by reference.

The primary system 110 can also include one or more systems downstream from fermentation. For example, after fermentation one or more bioproducts can be separated from beer to form at least one target bioproduct stream (e.g., ethanol) and one or more co-product streams (e.g., whole stillage). A co-product stream can encompass any stillage composition downstream from fermentation. As used herein, a “stillage composition” can include whole stillage, at least one stillage composition derived from whole stillage, and combinations thereof. Non-limiting examples of a stillage composition derived from whole stillage include thin stillage, concentrated thin stillage (syrup), defatted syrup, defatted emulsion, clarified thin stillage, distiller's oil, distiller's grain, distiller's yeast, and the like. Non-limiting examples of defatted stillage compositions include one or more defatted streams derived from thin stillage such as defatted syrup, defatted emulsion, and the like.

A separation system can separate a bioproduct from a beer using one or more of distillation, evaporation, separation based on particle size (e.g., filtration), or separation based on density (e.g., centrifugation). In some embodiments, a separation system can include one or more centrifuges (e.g., two-phase vertical disk stack centrifuge, three-phase vertical disk stack centrifuge, filtration centrifuge), one or more decanters (e.g., filtration decanters), one or more filters (e.g., fiber filter, rotary vacuum drum filter, filter device having one or more membrane filters), one or more screens (e.g., a “DSM” screen, which refers to a Dutch State Mines screen or sieve bend screen, and is a curved concave wedge bar type of stationary screen; a pressure screen; paddle screen; rotary drum screen; centrifugal screener; linear motion screen; vacu-deck screen; etc.), one or more brush strainers, one or more vibratory separators, one or more hydrocyclones, one or more presses, combinations of these and the like. Multiple separation systems can be used together and arranged in a parallel and/or series configuration.

Depending on the separation system selected, one or more process input streams can be separated into two or more output streams to produce an output stream that has a higher amount of solids as compared to other output streams. If desired, a separation system can include one or more evaporators and/or one or more dryers to further concentrate an output stream from any of the devices just mentioned.

As shown in FIG. 1A, an energy system 130 is represented in bioprocessing facility 105. Energy system 130 represents the various energy generating systems within bioprocessing facility 105. As explained below, an energy generating system can be part of a larger system in primary system 110 or can be a stand-alone energy generating system within bioprocessing facility 105.

In more detail, in some embodiments, one or more energy generating systems of energy system 130 may be physically integrated with and dedicated to a system within primary system 110. For example, a dryer system of primary system 110 may be configured to generate thermal energy using a combustion system as an energy generating system within the dryer system to form a hot gas to be used in the dryer system. As another example, a regenerative thermal oxidizer of primary system 110 may be configured to generate thermal energy using a combustion system as an energy generating system within the regenerative thermal oxidizer to form a hot gas to be used in the regenerative thermal oxidizer.

In some embodiments, one or more energy generating systems of energy system 130 may be integrated with one or more systems in primary system 110 within the bioprocessing facility 105, but are physically separated from the one or more systems in primary system 110 as a distinct energy generating system. For example, a steam boiler system may be configured to generate steam using a combustion system as an energy generating system, where the steam boiler system is physically separated from an evaporator system and/or distillation system. The steam can be transported to an evaporator system and/or distillation system via a piping system within the bioprocessing facility 105.

One or more energy generating systems of energy system 130 may operate independently from other energy generating systems of energy system 130 or may be integrated with other energy generating systems in energy system 130 to control the total energy that is generated by energy system 130.

In some embodiments, energy system 130 can generate electricity (electrical power) using a power-generation system as an energy generating system. A power generation system can generate electricity using one or more of wind power, solar power, hydroelectric power, steam-generated power, and combinations thereof.

Steam-generated power can generate electrical power using a steam turbine system that receives steam from a steam boiler system. In some embodiments, a steam boiler system can create steam at a temperature and pressure for a steam turbine system via combustion of one or more fuels 132 and one or more oxidants 133, which produces thermal energy and a gaseous exhaust (flue gas) 134 (combustion processes in energy system 130 are further discussed below). Non-limiting examples of inlet pressures and temperatures suitable for generating electricity in a steam turbine system are described below in connection with a steam boiler system.

Non-limiting examples of steam turbine systems include condensing turbine systems, non-condensing turbine systems, reheat turbine systems, extracting turbine systems, and combinations thereof.

In addition to producing electricity, in some embodiments energy system 130 can also include at least one thermal energy generating system to generate heat for use in one or more process streams and/or one or more systems in primary system 110. Heat generated can be present in a liquid or gas medium and be used to heat one or more process streams in primary system 110. A thermal energy generating system can generate heat via solar heat or heat from combustion. For example, a thermal energy generating system can produce thermal energy via combustion of one or more fuels 132 and one or more oxidants 133, which produces thermal energy (heat) 136 and a gaseous exhaust (flue gas) 134.

Fuels can include solid fuel, liquid fuel, gas fuel, and combinations thereof. Non-limiting examples of solid fuel include coal, renewable fuel, and combinations thereof. Non-limiting examples of renewable, solid fuel include biomass material such as wood, agricultural residue (e.g., corn stover), and combinations thereof. Liquid fuel can include fossil fuel, renewable fuel, and combinations thereof. Non-limiting examples of liquid fuel include gasoline, oil, ethanol, butanol, and the like. Gas fuel can include fossil fuel, renewable fuel, and combinations thereof. Non-limiting examples of gas fuel include natural gas, propane, methane, and the like.

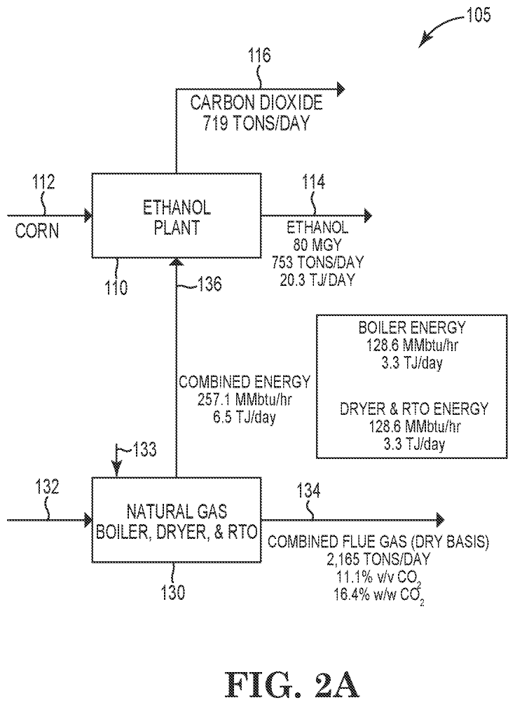

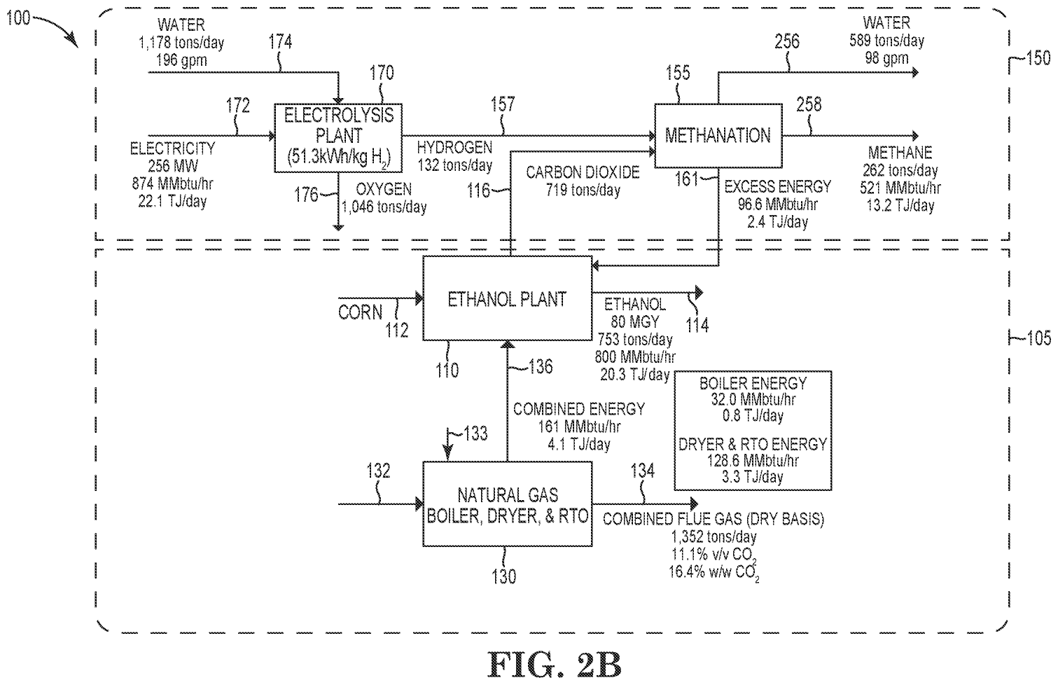

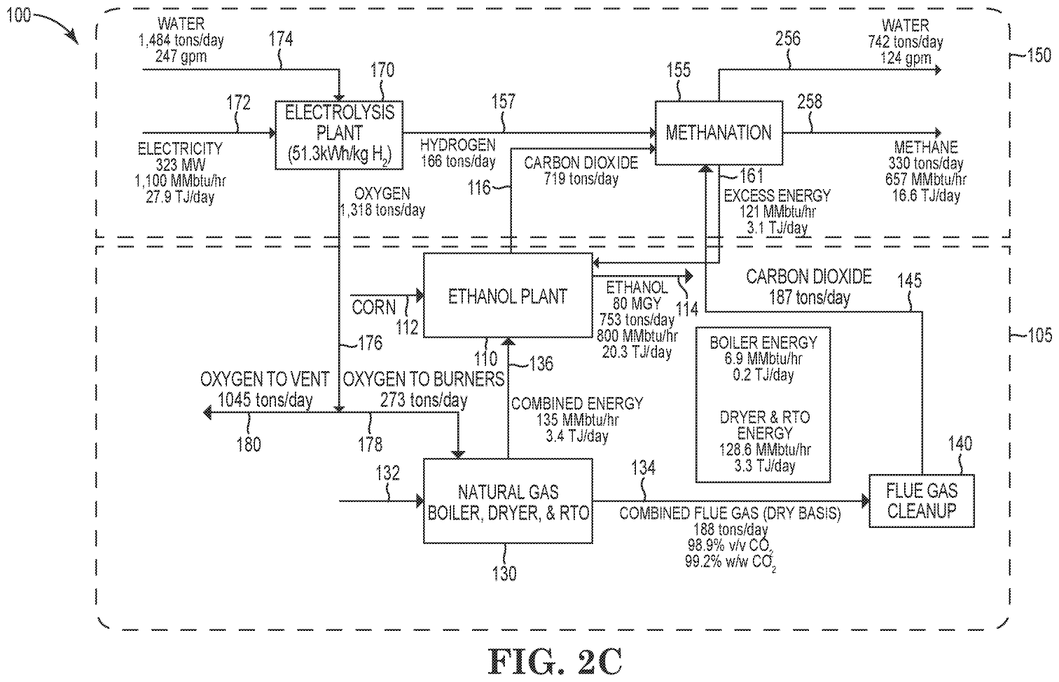

Oxidants have a relatively high oxidation potential. Non-limiting examples of gaseous oxidants include atmospheric oxygen, concentrated oxygen, and combinations thereof. Atmospheric oxygen is a component of atmospheric air, which includes about 78% nitrogen, 21% oxygen, and about 1% argon. Concentrated oxygen can be provided from a variety of sources having a variety of oxygen concentrations, an example of which is discussed below with respect to FIGS. 1B and 2C.

Combustion can produce a flue gas having a composition that depends on the fuel, oxidant, and combustion conditions (e.g., temperature and amount of oxidant). For example, the ratio of fuel to oxidant can be selected to facilitate complete combustion. When a hydrocarbon such as methane burns in oxygen, the reaction will primarily yield carbon dioxide gas and water. Trace elements that may be present can also react to form common oxides such as sulfur dioxide, iron (III) oxide, and the like. If atmospheric air is used a source for the oxidant oxygen, the nitrogen is generally not considered a combustible substance.

As mentioned above, in some embodiments, one or more energy generating systems of energy system 130 may be physically integrated with and dedicated to a system within primary system 110. Non-limiting examples of such thermal energy generating systems configured to generate thermal energy include at least one dryer system, at least one regenerative thermal oxidizer, and combinations thereof. In more detail, for example, a dryer system (e.g., a ring dryer system) can use combustion to form a hot flue gas that directly contacts and heats a back-end stillage stream to remove moisture from suspended solids (e.g., fiber and/or protein) to make, e.g., distillers' dried grain with solubles (DDGS) and/or a high protein product.

As also mentioned above, in some embodiments, one or more energy generating systems of energy system 130 may be integrated with one or more systems in primary system 110 within the bioprocessing facility 105, but are physically separated from the one or more systems as distinct energy generating systems. Non-limiting examples of such systems in primary system 110 that can receive and use thermal energy from one or more energy generating systems in energy system 130 include an evaporator system, a distillation system, and combinations thereof. For example, a steam boiler system can be configured to generate steam that is transported to an evaporator system and/or a distillation system via piping within the bioprocessing facility 105. For illustration purposes, in the context of a corn ethanol bioprocessing facility, a distillation system can use steam to indirectly heat fermented beer in a heat exchanger and distill ethanol from fermented beer. As yet another example, an evaporator system can use steam in a heat exchanger to indirectly heat a back-end stillage stream (e.g., thin stillage or composition derived from thin stillage) to remove water and concentrate the stillage stream.

For illustration purposes, additional non-limiting examples of process streams and systems in a corn grain ethanol plant that can be heated (e.g., indirectly or directly via a heated gas or liquid) by at least one thermal energy generating system in energy generating system 130 include front-end streams such as a slurry. For example, a front-end slurry can be exposed to a high-temperature cooking process for starch.

As mentioned above, a steam boiler system is an example of a thermal energy generating system that can create heat via combustion so that the heat can be used to form steam, which can be used to generate electricity and/or heat process streams. A steam boiler system heats water to generate pressurized steam that can be transported through a pipe system to one or more points of use in bioprocessing facility 105. In some embodiments, a steam boiler system generates steam suitable for generating electricity using a steam turbine system (discussed above). Non-limiting examples of an inlet pressure of steam suitable for generating electricity in a steam turbine system include a pressure in a range from 200 psig to 2000 psig, from 250 psig to 1000 psig, or even from 300 psig to 600 psig. Non-limiting examples of an inlet temperature of steam suitable for generating electricity in a steam turbine system include a temperature in a range from 200° C. to 300° C., or even from 215° C. to 255° C.

In some embodiments, a steam boiler system generates steam suitable for “process” steam (e.g., in an evaporator system and/or distillation system). Non-limiting examples of an inlet pressure of steam suitable for generating electricity in a steam turbine system include a pressure in a range from 50 psig to 200 psig, or even from 100 psig to 125 psig. Non-limiting examples of an inlet temperature of steam suitable for generating electricity in a steam turbine system include a temperature in a range from 150° C. to 200° C., or even from 170° C. to 185° C. In some embodiments, steam exhausted from a steam turbine system (e.g., non-condensing turbine system) is controlled by a regulating valve so that the steam is at a temperature and pressure that permits the steam exhausted from the steam turbine system to be used as “process” steam for, e.g., an evaporator system and/or a distillation system.

As shown in FIG. 1A, stream 116 of gas composition produced by fermentation in bioprocessing facility 105 can be transferred to reaction system 155 in chemical production system/facility 150 where carbon dioxide in the gas composition can be used as a reactant (discussed below). Fermentation in primary system 110 can produce a gas composition that has a relatively high concentration of carbon dioxide. Advantageously, in some embodiments, a relatively concentrated gas composition of carbon dioxide can be provided directly to a reaction system 155 in chemical production system 150 with little to no purification needed. In some embodiments, gas composition produced by fermentation has a concentration of carbon dioxide of at least 90 percent by weight on a dry basis, at least 95 percent by weight on a dry basis, at least 99 percent by weight on a dry basis, or even at least 99.9 percent by weight on a dry basis.

Optionally, in some embodiments, it may be desirable to remove one or more non-carbon dioxide components from the gas composition produced by fermentation prior to using it as a reactant in chemical production system 150. Non-limiting examples of the such non-carbon dioxide components include sulfur, oxygen, nitrogen, alcohol (e.g., ethanol), acetaldehyde, solid particulate, oil, and combinations thereof. One or more non-carbon dioxide components can be removed from the gas composition in stream 116 via amine-scrubbing system, a pressure-swing adsorption system, a cryogenic distillation system, a membrane separation system, filtration, fixed bed adsorption (e.g., using activated carbon), and combinations thereof.

As mentioned above, according to an aspect of the present disclosure, at least one reactant can react with the carbon dioxide to produce at least one reaction product via an exothermic reaction, and at least a portion of thermal energy 161 from the exothermic reaction can be used in the bioprocessing facility 150. In some embodiments, at least a portion of thermal energy 161 can offset at least a portion of the thermal energy generated using fuel in a thermal energy generating system of energy system 130.

In some embodiments, as shown in FIG. 1A, chemical production system 150 is co-located in physical proximity to (“on-site”) bioprocessing facility 150. Co-locating chemical production system 150 with bioprocessing facility 105 permits the chemical production system 150 and the bioprocessing facility 105 to be integrated with each so that one or more process streams can be readily shared among the chemical production system 150 and the bioprocessing facility 105. For example, materials produced in chemical production system 150 (e.g., oxygen, steam, and the like) can be readily transported to (e.g., via insulated piping) and shared with bioprocessing facility 105. Likewise, materials produced in bioprocessing facility 105 (e.g., carbon dioxide, and the like) can be readily transported to (e.g., via piping) and shared with chemical production system 150.

Chemical production system 150 includes a reaction system 155 configured to react at least one reactant and carbon dioxide to form the at least one reaction product via the exothermic reaction. Reaction system 155 includes one or more reaction vessels in fluid communication with one or more fermentation systems in the primary system 110 of the bioprocessing facility 150 to receive at least a portion of the carbon dioxide 116 produced in fermentation. The one or more reaction vessels in reaction system 155 are also in fluid communication with a stream 157 that includes at least one reactant that can react with the carbon dioxide via an exothermic reaction to produce a product stream 159 that includes at least one reaction product.

A wide variety of chemical production processes can be included in a chemical production system 150 that is co-located with bioprocessing facility 105 to directly or indirectly use carbon dioxide gas produced by fermentation for chemical synthesis. Nonlimiting examples of chemicals that can be synthesized in chemical production system 150 using carbon dioxide as a reactant include methane, methanol, formate, formic acid, ethanol, ethylene, propylene, sustainable aviation fuel (SAF), and combinations thereof. The reactant 157 can be selected to react with carbon dioxide and produce the desired reaction product 159 via an exothermic reaction. The physical state of the reactant 157 can also be selected as desired. For example, the reactant can be a solid, liquid, or gas. Non-limiting examples of reactants 157 include hydrogen gas.

Reactants can be exposed to reaction conditions suitable for chemical synthesis in reaction system 155. The reaction conditions can depend on the reaction scheme selected. For example, carbon dioxide and hydrogen can be mixed and then exposed to reaction conditions to form methane (e.g., via the Sabatier reaction). In some embodiments, carbon dioxide and hydrogen can be exposed to one or more catalysts at a temperature in a range from 200° C. to 550° C. and a pressure from 1 to 100 bar. Catalyst can be disposed in a variety of reactors such as an adiabatic bed reactor, a fluidized-bed reactor, a fixed-bed reactor, and the like. Non-limiting examples of suitable catalysts can be based on Ni, Ru, Rh, CO as active phases.

In some embodiments, one or more of the above-mentioned reaction products 159 can be chemical intermediates for the production of other final product chemicals at facility 100, for example, in subsequent reactions and/or processes in facility 100 (e.g., in bioprocessing facility 105 and/or chemical production system 150). In some embodiments, the reaction product 159 can be produced through a series of reactions in chemical production system 150. A non-limiting example of such a reaction product is sustainable aviation fuel (SAF), which can be produced from a chain of several unit operations including reverse water gas shift (RWGS), Fischer-Tropsch (FT), hydrotreating, hydrocracking, and fractionation.

In some embodiments, one or more of the above-mentioned reaction products 159 can be final products produced at facility 100 and can, e.g., be transported from facility 100 (“off-site”). For example, final products can be transported via a pipeline and/or transferred into one or more storage containers for transportation via truck, railcar, etc.

According to an aspect of the present disclosure, in some embodiments at least a portion of energy 161 from one or more exothermic reactions in chemical production system 150 can be used to supply heat and/or power (electricity) to one or more systems or processes in bioprocessing facility 105. The chemical production system 150 is configured to transport at least a portion of thermal energy 161 from the exothermic reaction in reaction system 155 to bioprocessing facility 105.

In addition, if desired, at least a portion of energy 161 from one or more exothermic reactions in chemical production system 150 can be used to supply heat and/or power to one or more systems or processes in facility 100 that are not part of bioprocessing facility 105 such as chemical production system 150. For example, at least a portion of energy 161 from one or more exothermic reactions in chemical production system 150 can be used to heat liquid water that may be used to form steam for a solid oxide electrolyzer that may be used in electrolysis system 170 (discussed below).

As mentioned, at least a portion of energy from an exothermic reaction in reaction system 155 can be used in a power generation system to generate electricity. For illustration purposes, one non-limiting example of using energy from an exothermic reaction to produce power for bioprocessing facility 105 includes forming steam and then using that steam to generate electricity in a steam turbine system. The steam turbine system may be one that is already present in bioprocessing facility 105 and as part of energy system 130, and/or the steam turbine system may be part of another area of facility 100 such as chemical production system 150.

In some embodiments, reaction system 155 can include one or more reaction vessels that function as a heat exchanger to transfer heat from the exothermic reaction to a heat-transfer fluid that is isolated from reactants and reaction product or products. Non-limiting examples of a heat exchanger that can be used as a reaction vessel in reaction system 155 include a shell-and-tube heat exchanger.

A shell-and-tube heat exchanger has a shell and tube arrangement, where a plurality of tubes are disposed inside the shell. The tubes (also referred to as “tube-side”) can be packed with catalyst to facilitate reaction between carbon dioxide and at least one reactant. The shell can have an interior space surrounding the tubes (also referred to as “shell-side”), where the interior space can be filled with heat-transfer fluid to extract heat from the exothermic reaction inside the tubes and transfer the heat to bioprocessing facility 105. The shell can have an inlet and outlet to receive heat-transfer fluid and discharge the heat-transfer fluid that has absorbed the energy from the exothermic reaction. In some embodiments, the heat-transfer fluid can include water. For example, liquid water can be introduced into the shell-side of a shell and tube reaction vessel at a temperature and pressure to facilitate transfer of heat from the tube-side to the water on the shell-side, and form steam that can be transferred for use in bioprocessing facility 105. In some embodiments liquid water can be introduced into a reaction vessel at a pressure from 10 pounds per square inch (psig) to 1,000 psig and a temperature in a range from 38° C. to 285° C. The exothermic reaction on the tube side can generate thermal energy that is transferred to the liquid water so that the liquid water changes phase to steam. The steam produced can be at a temperature and pressure suitable to generate electricity via a steam turbine (discussed above) and/or as process steam, e.g., for an evaporator system and/or a distillation system (discussed above). In some embodiments, the steam from reaction system 155 can be at pressure in a range from 10 psig to 1,000 psig and a temperature in a range from 115° C. to 285° C. If desired, the temperature and/or pressure of the steam can be regulated depending on how it is to be used.

As also mentioned, at least a portion of energy from an exothermic reaction in reaction system 155 can be used to heat one or more process streams in one or more systems of bioprocessing facility 105 in addition to or instead of generating electricity. For illustration purposes, one non-limiting example of using energy from an exothermic reaction to heat one or more process streams in bioprocessing facility 105 includes forming steam and then using that steam to heat a given process stream, e.g., via indirect heating. One or more process streams in bioprocessing facility 105 can be heated via one or more systems in bioprocessing facility 105, but by using at least a portion of the thermal energy from reaction system 155 instead of receiving all thermal energy from a thermal energy generating system in energy system 130. Non-limiting examples of systems in primary system 110 that can receive can receive thermal energy from reaction system 155 (instead of or in addition to energy system 130 of bioprocessing facility 105) include an evaporator system, a distillation system, a dryer system, and combinations thereof.

Steam can be formed in reaction system 155 via a heat exchanger as discussed above. The steam can be provided at a temperature and pressure to facilitate heating a process stream. In some embodiments, the steam can be provided at the same or similar conditions as boiler steam discussed above in connection with a thermal energy generating system in energy system 130. As mentioned above, in some embodiments, the steam generated in reaction system 155 can replace a portion or all of the boiler steam generated by one or more thermal energy generating system in energy system 130 of bioprocessing facility 105. In some embodiments, the steam from reaction system 155 can be provided to such systems at a temperature and pressure discussed above.

In some embodiments, reaction system 155 can produce relatively high-pressure steam, which can be used by a steam turbine system to generate electricity for bioprocessing facility 105. The pressure of the steam can drop after being used to drive the turbines in a steam turbine system, which can be a low-pressure steam the same as or similar to the pressure of boiler steam used as “process” steam.

A chemical production system according to the present disclosure can obtain one or more reactants from a variety of sources. For example, one or more reactants may be obtained from a commercial supplier and can be transported to the chemical production system 150. As another example, one or more reactants may be produced on-site by the chemical production system 150. A non-limiting example of producing a reactant at a chemical production system is illustrated in FIG. 1A. As shown in FIG. 1A, a stream 157 of hydrogen can be produced via an electrolysis system 170. Electrolysis system 170 is configured to form hydrogen and oxygen from water.

Electrolysis of water (also referred to as “water splitting”) is a process of using electricity to decompose liquid water into oxygen gas and hydrogen gas. The process uses an electrical power source that is applied to an electrolyzer that includes an anode and a cathode separated by an electrolyte material. Hydrogen gas forms at the cathode and oxygen gas forms at the anode. Non-limiting examples of suitable electrolyzers included polymer electrolyte membrane (PEM) electrolyzers, alkaline electrolyzers, and solid oxide electrolyzers.

In a PEM electrolyzer, the electrolyte includes a solid plastic material. Liquid water is introduced to the PEM electrolyzer where water reacts at the anode to form oxygen and positively charged hydrogen ions. Hydrogen ions selectively flow through the PEM membrane to the cathode and electrons flow through an external circuit. Hydrogen ions combine with electrons at the cathode to form hydrogen gas. PEM electrolysis systems can operate at a temperature in a range from 50° C.-90° C. (122° F.-194° F.) and at a pressure up to 435 psig.

In an alkaline electrolyzer, hydroxide ions pass through the electrolyte from the cathode to anode while hydrogen gas is produced at the cathode. The electrolyte can be a solid or liquid material. An example of a liquid material includes an alkaline solution of a metal hydroxide such as sodium hydroxide or potassium hydroxide.

In a solid oxide electrolyzer, the electrolyte is a solid ceramic material and selectively conducts oxygen ions at an elevated temperature. Liquid water is used to form steam. Steam present at the cathode combines with electrons to form hydrogen gas and negatively charged oxygen ions that pass through the solid ceramic electrolyte and react at the anode to form oxygen gas.

As shown in FIG. 1A, a supply 174 of liquid water is provided to the electrolysis system 170 for conversion of the liquid water to hydrogen gas and oxygen gas. A variety of sources of water can be used as supply 174. Depending on the source of the water, the water may be filtered and/or deionized to remove particulates, minerals, and the like, e.g., to satisfy an ASTM Type II water specification having a conductivity of less than 1 μS/cm, or an ASTM Type I water specification having a conductivity of less than 0. 056 μS/cm.

As described above, an electrolyzer is configured to produce a hydrogen gas stream that is separate from the oxygen gas stream. Referring to FIG. 1A, the electrolysis system 170 is in fluid communication with a reaction vessel in reaction system 155 to transport a stream 157 of hydrogen gas to the reaction vessel to react with carbon dioxide gas provided by stream 116 and form at least one reaction product via the exothermic reaction. The gas composition in stream 157 can be relatively concentrated in hydrogen. In some embodiments, the gas composition discharged from the electrolysis system via stream 157 has a concentration of hydrogen of at least 95 percent by weight on a dry basis, at least 99 percent by weight on a dry basis, at least 99.9 percent by weight on a dry basis, at least 99.99 percent by weight on a dry basis, or even at least 99.999 percent by weight on a dry basis. The gas composition comprising oxygen can be discharged from the electrolysis system 170 via stream 176. The gas composition in stream 176 can be relatively concentrated in oxygen. In some embodiments, the gas composition discharged from the electrolysis system has a concentration of oxygen of at least 90 percent by weight on a dry basis, at least 95 percent by weight on a dry basis, or even at least 99 percent by weight on a dry basis. The stream 176 of concentrated oxygen gas can be used as desired. In some embodiments, it can be used as a source of oxygen for combustion (see FIG. 1B discussion below).

In some embodiments, e.g., depending on the electrolyzer used, the oxygen and/or hydrogen produced in electrolysis system 170 can be further processed (e.g., purified, heated, compressed, and/or the like) if desired. For example, hydrogen may be treated to remove any residual oxygen, e.g., via a “deoxo” process that is a catalytic purification process. In some embodiments, the oxygen may be provided directly to a combustion process and/or the hydrogen may be provided directly to reaction system.

Referring to FIG. 1A, one or more sources of power 172 are supplied to the electrolysis system, e.g., to supply power to one or more electrolyzers described above. In some embodiments, at least a portion of the electricity 172 is generated using renewable energy. A reactant such as hydrogen that is produced from renewable energy can be referred to as a “green” reactant. With growing availability of green hydrogen, it may be desirable to combine “green” hydrogen and “green” carbon dioxide (CO₂) that is produced via fermentation at bioprocessing facility 105, as discussed above. This would be synergistic in part because 1) it would provide a value-added use for the CO₂ close to the source of production at a bioprocessing facility and 2) some chemical production processes are exothermic resulting in a significant amount of energy that can be useful in a bioprocessing facility 105.

Non-limiting examples of renewable energy sources include wind power, solar power, hydroelectric power, combustion of biomass, and combinations thereof. Non-limiting examples of biomass that can be burned in a power generation system for energy include wood, agricultural residue (e.g., corn stover), and combinations thereof.

According to another aspect of the present disclosure, oxygen produced in an electrolysis system as described herein can be used as at least a partial source of oxygen for one or more combustion processes associated with facility 100 (e.g., bioprocessing facility 105) to produce an exhaust (flue) gas that is relatively more concentrated in carbon dioxide, which can in turn be used as an additional source of carbon dioxide for reaction system 155. Advantageously, by comingling one or more outputs from bioprocessing facility 105 with chemical production system 150, and vice versa, the amount of recoverable exothermic energy of reaction from reaction system 155 for use in bioprocessing facility 105 can be increased. If desired, such increased amount of thermal energy recovered from reaction system 155 can be used to offset other (e.g., fossil fuel based) energy inputs into energy system 130 for bioprocessing facility 105.

In contrast, when ambient air is used in a combustion process, a flue gas is produced having carbon dioxide that is diluted by the nitrogen content of the ambient air. For example, the concentration of carbon dioxide in a flue gas produced with ambient air is approximately 16% on a mass basis. As the concentration of oxygen is increased and the amount of nitrogen gas is decreased in the gas provided to combustion, the carbon dioxide gas in the flue gas becomes more concentrated (and the concentration of nitrogen gas decreases). Advantageously, a gas composition produced directly from electrolysis of water can have a relatively much higher concentration of oxygen as compared to ambient air.

A non-limiting example of a facility and process for using oxygen produced in an electrolysis system as at least a partial source of oxygen for one or more combustion processes associated with facility 100 is illustrated with reference to FIG. 1B. Reference characters in FIG. 1B that are described in connection with FIG. 1A may not or may not be repeated in connection with FIG. 1B. As shown in FIG. 1B, the stream of oxygen 176 produced in the electrolysis system 170 is in fluid communication with the at least one thermal energy generating system in energy system 130 to provide oxygen via stream 178 for a combustion process. Optionally, if desired, any remaining oxygen 180 that may not be needed for combustion in a thermal energy generating system can be diverted to one or more other destinations. One non-limiting example of another destination includes aerating one or more process compositions in bioprocessing facility 105 such as a propagation system for growing a population of microorganisms used in fermentation. Another non-limiting example of another destination includes transporting (e.g., via pipeline, railcar, containers, and the like) the oxygen as a co-product off-site from facility 100.

In some embodiments, the oxygen produced in electrolysis system 170 can be at a concentration and pressure such that it can be directly supplied to a combustion process in energy system 130 without any purification or pressurizing. In some embodiments, the gas composition in stream 178 has a concentration of oxygen of at least 90 percent by weight on a dry basis, at least 95 percent by weight on a dry basis, at least 99 percent by weight on a dry basis, or even at least 99.9 percent by weight on a dry basis.

As discussed in FIG. 1A above, generating thermal energy in energy system 130 for the bioprocessing facility 105 via a combustion process produces a flue gas. In FIG. 1B, the flue gas is relatively much more concentrated in carbon dioxide because a relatively concentrated source of oxygen is provided from electrolysis via stream 178 instead of ambient air. In some embodiments, the flue gas in stream 134 directly from combustion in energy system 130 has a concentration of carbon dioxide of at least 85 percent by weight on a dry basis, at least 90 percent by weight on a dry basis, at least 95 percent by weight on a dry basis, at least 99 percent by weight on a dry basis, or even at least 99.9 percent by weight on a dry basis.

Optionally, as shown in FIG. 1B, the stream 134 of flue gas can be cleaned via one or more separation systems 140 to separate one or more non-carbon dioxide gases from carbon dioxide gas so that a relatively more concentrated stream 145 of carbon dioxide can be transported as reactant for reaction system 155. Non-limiting examples of separation system 140 include one or more of an amine-scrubbing system, a pressure-swing adsorption system, a cryogenic distillation system, and a membrane separation system.

### Example

A prophetic example comparing theoretical calculations of energy among three scenarios using a corn ethanol bioprocessing facility as a baseline will be described using FIGS. 2A-2C. Reference characters in FIGS. 2A-2C that are described in connection with FIGS. 1A and 1B may or may not be repeated in connection with FIGS. 2A-2C. A major difference among FIGS. 1A and 2B is that FIG. 2B shows theoretical calculations of flowrates of certain process streams and/or energy generation for a corn ethanol bioprocessing facility integrated with a methane production system and a water electrolysis system. Similarly, a major difference among FIGS. 1B and 2C is that FIG. 2C shows theoretical calculations of flowrates of certain process streams and/or energy generation for a corn ethanol bioprocessing facility even further integrated with a methane production system and a water electrolysis system.

FIG. 2A shows a non-limiting embodiment of a bioprocessing facility 105 as a corn ethanol bioprocessing facility. As shown in FIG. 2A, corn ethanol bioprocessing facility 105 includes a primary system 110 that receives corn grain feedstock 112. The primary system 110 includes one or more fermentation vessels that produce ethanol as a bioproduct 114 along with a gas composition 116 concentrated in carbon dioxide gas.

As shown in FIG. 2A, energy calculations are provided for a steam boiler system, a dryer system, and a regenerative thermal oxidizer as thermal energy generating systems in energy system 130. As shown in FIG. 2A, the combined energy generated by the steam boiler system, the dryer system, and the regenerative thermal oxidizer is 257.1 MMbtu/hr, of which 128.6 MMbtu/hr is attributed to the steam boiler system. The calculations are based on using natural gas as the fuel 132 and ambient air as the source of combustion oxygen 133. As can be seen, using ambient air to supply oxygen to these combustion processes produces a combined flue gas that contains carbon dioxide that is significantly diluted by the nitrogen content of the ambient air. The carbon dioxide is present at approximately 16% on a mass basis.

FIG. 2B shows a non-limiting embodiment of a facility and process for making methane at a corn ethanol bioprocessing facility using “green” carbon dioxide and “green” hydrogen via an exothermic reaction and using at least a portion of thermal energy from the exothermic reaction in the corn ethanol bioprocessing facility 105. FIG. 2B is similar to FIG. 2A, but FIG. 2B integrates corn ethanol bioprocessing facility 105 with a chemical production facility 150 to make water vapor stream 256 and methane stream 258 using carbon dioxide 116 from corn ethanol bioprocessing facility 105. As can be seen, thermal energy 161 from the exothermic reaction can be used in corn ethanol bioprocessing facility 105. As the theoretical calculations in FIG. 2B show, the combined flue gas stream 134 has a somewhat lower mass rate than the baseline corn ethanol bioprocessing facility 105 shown in FIG. 2A due to the amount of energy recovered 161 from the methanation process in chemical production system 150 and the energy system 130 has a corresponding reduction in natural gas input. As shown in FIG. 2B, the combined energy generated by the steam boiler system, the dryer system, and the regenerative thermal oxidizer is 161 MMbtu/hr, of which 32 MMbtu/hr is attributed to the steam boiler system. As can also be seen, the carbon dioxide content of the combined flue gas stream 134 is approximately 16% on a mass basis, which is the same as that shown in FIG. 2A and to be expected. If desired, the carbon dioxide in the combined flue gas stream 134 of FIG. 2B could be recovered and used as an additional input to the methanation process of the chemical production system 150 to produce additional methane 258. Purifying pure carbon dioxide that is present in combined flue gas stream 134 of FIG. 2B for use as feedstock to the methanation process could be performed with one or more additional unit operations such as either amine scrubbing, pressure swing adsorption, cryogenic distillation, or membrane separation, which may or may not be worth the investment.

FIG. 2C shows a non-limiting embodiment of a facility and process for making methane at a corn ethanol bioprocessing facility using “green” carbon dioxide and “green” hydrogen via an exothermic reaction and using at least a portion of thermal energy from the exothermic reaction in the corn ethanol bioprocessing facility 105. FIG. 2C is similar to FIG. 2B, but FIG. 2C integrates the oxygen produced in electrolysis system 170 with the combustion processes associated with thermal generating systems in energy system 130 to produce flue gas 134 that is relatively much more concentrated in carbon dioxide as compared to FIGS. 2A and 2B. This results in a flue gas stream 134 that is essentially pure carbon dioxide gas on a dry basis and is much easier to capture and use as a feedstock or sequester underground in permanent geologic storage than the carbon dioxide in a typical combustion flue gas stream shown in FIGS. 2A and 2B. As shown in FIG. 2C, recovering this additional carbon dioxide as feedstock for the methanation process increases the production of methane and also the amount of excess energy that can be recycled from the methanation process back to the corn ethanol bioprocessing facility 105. This in turn reduces the amount of natural gas input energy needed by the energy system 130 of the ethanol plant and the amount of combined flue gas relative to FIGS. 2B and 2C. As shown in FIG. 2C, the combined energy generated by the steam boiler system, the dryer system, and the regenerative thermal oxidizer is 135 MMbtu/hr, of which 6.9 MMbtu/hr is attributed to the steam boiler system. In the example shown in FIG. 2C, only minimal processing, if any, would be required to clean up the combined flue gas before the carbon dioxide can be used by the methanation process.

In FIG. 2B, the methanation process produces half (98 gpm) of the required water (196 gpm) for electrolysis. In FIG. 2C, the methanation process produces half (124 gpm) of the required water (247 gpm) for electrolysis.

In some embodiments, there may be a water cleanup process to recycle water produced in the methanation process back to the electrolyzer in the electrolysis system.

The calculations in FIGS. 2B and 2C are for the catalytic reaction of carbon dioxide with electrolysis hydrogen to produce methane. These estimates do not include any energy consumption in the methanation synthesis area (such as heating the CO₂, separating the products, etc.), so the actual amount of energy that could be returned to the bioethanol plant is lower than what is indicated.

For methanation in FIG. 2B, the percentage of energy input (874 MMbtu/hr) into electrolysis system 170 that is converted into energy content (521 MMbtu/hr) of the final methane produce from reaction system 155 is 59.6% ((521 MMbtu/hr/874 MMbtu/hr)*100). For methanation in FIG. 2C, the percentage of energy input (1100 MMbtu/hr) into electrolysis system 170 that is converted into energy content (657 MMbtu/hr) of the final methane produce from reaction system 155 is 59.7% ((657 MMbtu/hr/1100 MMbtu/hr)*100).

What is claimed is:

1. A method of making a reaction product using carbon dioxide produced at a bioprocessing facility, wherein the method comprises:
fermenting a fermentable composition at a bioprocessing facility, wherein fermenting generates at least one target biochemical and carbon dioxide;
reacting at least one reactant and carbon dioxide to form the at least one reaction product via an exothermic reaction, wherein at least a portion of the carbon dioxide is from the fermenting; and
using at least a portion of thermal energy from the exothermic reaction in the bioprocessing facility.

2. The method of claim 1, wherein at least a portion of the thermal energy is used to generate electricity for at least the bioprocessing facility.

3. The method of claim 1, wherein at least a portion of the thermal energy is used in at least one or more systems in the bioprocessing facility, wherein the one or more systems are chosen from an evaporator system, a distillation system, a dryer system, a power generation system, and combinations thereof.

4. The method of claim 1, wherein the at least one reactant is produced by a chemical production system that is co-located with the bioprocessing facility.

5. The method of claim 4 wherein the at least a portion of the thermal energy is used in a power generation system to generate electricity for at least the bioprocessing facility and/or the chemical production system.

6. The method of claim 1, wherein the at least one reactant comprises hydrogen.

7. The method of claim 6, wherein at least a portion of the hydrogen is produced via electrolysis of water.

8. The method of claim 7, wherein electricity is used for the electrolysis of water, and wherein at least a portion of the electricity is generated using renewable energy.

9. The method of claim 8, wherein at least a portion of the electricity is generated via one or more sources of renewable energy chosen from wind power, solar power, hydroelectric power, combustion of biomass, and combinations thereof.

10. The method of claim 1, wherein the at least one reaction product is chosen from methane, methanol, formate, formic acid, ethanol, ethylene, propylene, and combinations thereof.

11. The method of claim 7, wherein the electrolysis of water produces hydrogen and oxygen, and further comprising:
generating energy for the bioprocessing facility via at least one combustion process that produces a flue gas comprising carbon dioxide; and
providing oxygen from the electrolysis of water for at least a portion of oxygen used in the at least one combustion process.

12. The method of claim 11, wherein the at least one combustion process uses at least one fuel chosen from at least one biomass material, at least one gas fuel, at least one liquid fuel, and combinations thereof.

13. The method of claim 11, further comprising providing at least a portion of the flue gas as at least a portion of the carbon dioxide in the reacting at least one reactant and carbon dioxide.

14. The method of claim 1, wherein the at least one reactant is produced by a chemical production system that is co-located with the bioprocessing facility, wherein the at least one reactant comprises hydrogen that is produced via electrolysis of water, wherein the electrolysis of water produces hydrogen and oxygen, and wherein at least a portion of thermal energy from the exothermic reaction is used in one or more systems in the bioprocessing facility, and further comprising:
generating thermal energy for the bioprocessing facility via at least one combustion process that produces a flue gas comprising carbon dioxide, wherein at least a portion of the thermal energy from the at least one combustion process is used in one or more systems in the bioprocessing facility; and
providing oxygen from the electrolysis of water for at least a portion of oxygen used in the at least one combustion process; and
providing at least a portion of the flue gas as at least a portion of the carbon dioxide for reaction between the at least one reactant and carbon dioxide.

15. The method of claim 14, wherein at least a portion of the thermal energy from the exothermic reaction and at least a portion of the thermal energy from the at least one combustion process are used in one or more systems in the bioprocessing facility and/or the chemical production system, wherein the one or more systems are chosen from an evaporator system, a distillation system, a dryer system, a power generation system, a regenerative thermal oxidizer system, and combinations thereof.

16. The method of claim 14, wherein a gas composition having a concentration of carbon dioxide of at least 90 percent by weight on a dry basis is directly obtained from the fermenting, wherein a gas composition having a concentration of oxygen of at least 90 percent by weight on a dry basis is directly obtained from the electrolysis, and/or wherein the flue gas has a concentration of carbon dioxide of at least 85 percent by weight on a dry basis and is directly obtained from the at least one combustion process.

17. The method of claim 1, further comprising using at least a portion of the reaction product as a reactant to form a derivative thereof and/or transferring at least a portion of the reaction product into one or more storage containers.

18. The method of claim 17, wherein the derivative thereof comprises sustainable aviation fuel (SAF).

19. The method of claim 1, wherein the fermentable composition comprises one or more sugars derived from at least one grain starch, at least one cellulosic polysaccharide, and combinations thereof, wherein the at least one target biochemical comprises at least one alcohol.

20. The method of claim 1, wherein fermentable composition comprises one or more sugars derived from corn starch, and wherein the at least one target biochemical comprises ethanol.

21. A facility comprising:
a bioprocessing facility comprising:
a fermentation system configured to ferment a fermentable composition and generate at least one target biochemical and carbon dioxide; and
one or more systems configured to use thermal energy for one or more processes in the bioprocessing facility;
a chemical production system that is co-located with the bioprocessing facility, wherein the chemical production system is in fluid communication with the fermentation system to receive at least a portion of the carbon dioxide, wherein the chemical production system comprises:
a source of at least one reactant that can react with the carbon dioxide via an exothermic reaction to produce at least one reaction product; and
a reaction vessel configured to react the at least one reactant and carbon dioxide to form the at least one reaction product via the exothermic reaction,
wherein the chemical production system is configured to transport thermal energy from the exothermic reaction, wherein the facility is configured to use at least a portion of the thermal energy to generate electricity for the bioprocessing facility and/or wherein the facility is configured to use at least a portion of the thermal energy in one or more systems in the bioprocessing facility, wherein the one or more systems are chosen from an evaporator system, a distillation system, a dryer system, a power generation system, and combinations thereof.

22. The facility of claim 21, wherein the facility further comprises:
at least one thermal energy generating system configured to generate thermal energy for the bioprocessing facility and produce a flue gas comprising carbon dioxide via a combustion process, wherein the bioprocessing facility is configured to use at least a portion of the thermal energy in one or more systems in the bioprocessing facility, and wherein the at least one thermal energy generating system is in fluid communication with the reaction vessel to provide at least a portion of the flue gas to the reaction vessel so that carbon dioxide can react with the at least one reactant to form the at least one reaction product via the exothermic reaction; and
wherein the chemical production system further comprises:
an electrolysis system configured to form hydrogen and oxygen from water, wherein the electrolysis system is in fluid communication with the reaction vessel to provide hydrogen to the reaction vessel to react with carbon dioxide and form the at least one reaction product via the exothermic reaction, and wherein the electrolysis system is in fluid communication with the at least one thermal energy generating system to provide oxygen to the at least one thermal energy generating system for the combustion process.

23. The facility of claim 22, wherein the at least one thermal energy generating system is chosen from at least one steam boiler system, at least one dryer system, at least one power generation system, at least one regenerative thermal oxidizer, and combinations thereof.
